(19) United States
(12) Patent Application Publication
(10) Pub. No.: US 2006/0146010 A1
(43) Pub. Date: Jul. 6, 2006

(54) Computer assisted manipulation of catheters and guide wires

(76) Inventor: M. Bret Schneider, (US)

Correspondence Address: Deanna J Shirley, 3418 Baldwin Way, Santa Rosa, CA, 95403, US

(21) Appl. No.: 10/562,341

(22) PCT Filed: Jun. 22, 2004
(86) PCT No.: PCT/US04/20159

§ 371 Date: Dec. 23, 2005

(30) Foreign Application Priority Data
Jun. 27, 2003 (US) 10608862

(51) Int. Cl. G09G 5/00

(52) U.S. Cl. 345/156

(57) ABSTRACT

Computer-assisted methods and systems for manipulating elongate members during medical procedures are provided. Electromechanical devices are computer driven to manipulate the elongate members, which a user can direct through computer interfaces like graphical user interfaces and pointing devices.

### BACKGROUND OF THE INVENTION

The present invention relates to computer-assisted manipulation of elongate (flexible or rigid) members while performing medical procedures or surgery. More specifically, the invention relates to computer-assisted manipulation of catheters and guide wires during medical procedures.

There are numerous kinds of minimally surgical procedures that require the manipulation of elongated elongate members through areas of a patient's body. A common example is angioplasty that attempts to increase blood through a blocked artery. The elongated elongate members can include guide catheters, interventional catheters (e.g., angioplasty or stent), guide wires, and the like. Typically, such procedures are performed by physicians who are in the fields of cardiology, radiology, and neurosurgery.

FIG. 1 shows an illustration of a common medical procedure such as angioplasty. An incision is made to reach a large artery, such as incision 1 in the femoral artery in a patient's leg. Other arteries such as in the arm can also be utilized. Elongate members 3 are inserted in the artery and manually directed up to a targeted lesion 5 for the desired procedure.

For example, elongate members 3 can include a guide catheter, a guide wire, an angioplasty balloon catheter, an angioplasty stent catheter, and an atherectomy catheter. The angioplasty balloon catheter, an angioplasty stent catheter, and an atherectomy catheter are examples of what will be called “interventional catheters.” In a typical angioplasty procedure, the guide wire is inserted in the guide catheter which is then manually steered through the arteries to the coronary os 7. The guide wire is then advanced to targeted lesion 5.

The angioplasty catheter is then inserted in the guide catheter but around the guide wire. In this manner, the angioplasty catheter follows the path of the guide catheter and guide wire to targeted lesion 5. Once at the lesion, a balloon on the angioplasty catheter may be inflated in order to dilate the lumen and thereby increase blood flow.

Other interventional catheters besides the angioplasty catheter can also be used. For example, a stent catheter can be utilized to insert a stent at targeted lesion 5 in order to increase blood flow. Physicians often utilize a combination of interventional catheters in order to achieve the desired results.

Although these medical procedures have met with great success, the current techniques for performing these procedures have numerous disadvantages. A major drawback to the use of elongate members in the minimally invasive surgical environment from the perspective of the physician is significant exposure to radiation due to the fluoroscopic cameras used to visualize the path and tip of guide wires, guide catheters, balloon catheters, biopsy needles, and other minimally invasive instruments. Lead-lined garments are typically worn by physicians, nurses and technicians during such procedures to reduce radiation exposure. However, the use of such garments itself presents an occupational hazard due to the wear and tear inflicted on the user's body, secondary to the weight and stiffness, and reduced ventilation that characterize such wearable radiation shields. Additionally, the arms and head of the user are not typically covered by such garments, making radiation shield at best incomplete.

Another disadvantage is that the elongate members are quite long and difficult to manually manipulate. For example, the length of the typical elongate members can be as follows:

Guide catheter—100 cm

Balloon catheter—130 cm

Stent catheter—135 cm

Guide wire—300 cm

It can often require the cooperation of two or more individuals to manually manipulate these long elongate members in order to perform a procedure.

Additionally, it can be very difficult to manually maneuver the elongate members to their desired destination, manipulating a precise portion of the device to an exactly targeted spot within the body. This difficulty can be compounded by the complication that when a physician retracts one of the elongate members, such as to use a different elongate member, the other elongate members may be accidentally drawn from their desired location. This can require the elongate members to once again be directed to their desired location.

There is a difference of opinion about how beneficial or necessary, if at all, is the haptic feedback of the force from the tip of a guide wire or a catheter back to the operator. Many operators say they work primarily or exclusively by using visual feedback from fluoroscopic imaging. In any case, it is possible to provide force feedback to the operator.

It would be desirable to have innovative techniques by which persons performing a minimally invasive procedure under fluoroscopic visualization could move and steer elongate members to their intended location without suffering radiation exposure in the process. It would also be beneficial to provide a computer-assisted system that allows a physician to direct, manipulate and retract the elongate members in a more efficient manner.

### SUMMARY OF THE INVENTION

The present invention provides techniques for the computer-assisted, remote control manipulation of elongate members such as catheters and guide wires in medical procedures. For example, a computer system can utilize electromechanical devices in order to manipulate the elongate members. A user can select how she desires to manipulate the elongate members through a graphical user interface. Additionally, the user can direct the manipulation of the elongate members through a pointing device such as a joystick.

Advantages of the invention can include the ability to manipulate minimally invasive surgical tools while under fluoroscopic visualization by remote control, virtually eliminating radiation exposure and permitting, if desired, the operating physician and the patient being separated by great geographical distances. Other advantages of the invention can include that fewer individuals may be required to manipulate the elongate members, the elongate members may be manipulated in a more efficient manner (e.g., to the desired destination) and elongate members can be exchanged without affecting the position of the other elongate members.

Other functions related to a procedure may also be remotely controlled by the hardware and software interfaces. Such functions include the motorized advancement or retraction of a syringe plunger, so as to inject contrast media, flush the catheter with saline or heparin, or to draw a sample of blood for a blood gas analysis. Additionally, external equipment, such as intravascular arterial measurement devices may be triggered via specific buttons or other controls on the software or hardware interfaces of the invention. Some specific embodiments of the invention are described below.

In one embodiment, the invention provides a method of manipulating an elongate member during a medical procedure. Input is received from a user to manipulate the elongate member. Signals are sent to advance the elongate member if the input directs advancement of the elongate member. Signals are sent to retract the elongate member if the input directs retraction of the elongate member. And, signals are sent to rotate the elongate member if the input directs rotation of the elongate member.

In another embodiment, the invention provides an apparatus for manipulating elongate members during medical procedures. A base is coupled to an elongate member, the base being rotatable along an axis parallel to the elongate member. A first motor is coupled to the base that advances or retracts the elongate member along the axis. And, a second motor is coupled to the base that rotates the base, whereby the elongate member is rotated around the axis.

In another embodiment, the invention provides a method of manipulating an elongate member during a medical procedure. Two elongate members are retracted where a first elongate member is within the lumen of a second elongate member. The first elongate member is advanced relative to the second elongate member. In some embodiments, the first elongate member is advanced to substantially counter retraction caused by the retraction.

In another embodiment, the invention provides an apparatus for manipulating elongate members during medical procedures. A drum is coupled to two elongate members where a first elongate member is within the lumen of a second elongate member, the drum being rotatable along an axis perpendicular to the two elongate members and comprising a clip to retain the second elongate member such that when the drum rotates, the second elongate member is retracted along a first direction. A wheel is coupled to the drum such that the rotation of the drum also rotates the wheel and the first elongate member is retracted along the first direction, wherein the wheel rotates to advance the first elongate member along a second direction opposite the first direction.

The maneuvers associated with the invention are of two types. The first type is the set of large movements associated with placing a catheter and/or wire into position from outside the patient's body to the target location. The second is the set of small movements over relatively short distances to thread through a smaller vessel such as a coronary artery. The first type is done with the invention's front-stage drive wheel and stage rotation, perhaps in connection with the back-stage drum and perhaps drive wheel. The second type is done moving the guide wire with the invention's micro-positioning apparatus (“TurboTorquer” or “Fine Motion Controller”). Some small movements can also be done with the first type of apparatus such as using the front-stage drive wheel to advance an interventional catheter over a guide wire that has been threaded through a lesion within a vessel.

The combined linear and torquing movements are performed using a linear motor gear box running on a threaded rod to which is attached a torquing motorized gear drive that holds the guide wire. The advancing and withdrawing movements of the linear movement is controlled by one pair of switched while the clockwise and counter-clockwise rotation of the torquing movement is controlled by a second pair of switches.

In another embodiment, the entire invention has a linear configuration (no drum) and uses clamshell designs so that catheter or wire devices do not have to be threaded through rings or tubes.

Haptic force feedback can be provided in at least three ways. The first is to measure the force back on the wire or catheter at a point in front of the point where it is being driven by the robotic manipulator. The second is to float the mechanism driving the wire or catheter on a platform, the force back from which can be measured. The measurement component is then calibrated by zeroing the system when the drive is advancing the wire or catheter forward with no force back at the top of the wire or catheter. Then additional known forces placed at the tip of a wire or catheter can be used to calibrate the force feedback. Alternatively, the same approach can be used to measure clockwise or counter-clockwise rotational forces. A third mechanism is to measure the force at the tip of the wire or catheter.

Because the invention allows minimally invasive procedures done under fluoroscopic visualization to be done by remote control, the physician may stand or sit at a distance from radiation-emitting fluoroscopic cameras. For example, the physician operator can work within a compact area placed behind a freestanding transparent radiation shield, such as those standard in angioplasty catheterization laboratories. Behind the screen, but in front of where the operator sits or stands, can be a compact control panel having a computer, joystick and fluoroscopic display. The operator may step out from the protective screen while fluoroscopic cameras are off to perform manual adjustments to the equipment setup. For example, the operator, without need for fluoroscopic, radiation-producing visualization, may manually change catheters or wires mounted on the system. Likewise, clips may be manually fastened or unfastened, and catheters and wires may be manually shifted from one channel to another on the wheels of the module base. Alternatively, other personnel, such as nurses or technicians, may be called to do such manual tasks.

Other features and advantages of the invention will become readily apparent upon review of the following description in association with the accompanying drawings.

### BRIEF DESCRIPTION OF TIRE DRAWINGS

FIG. 1 shows an illustration of a medical procedure that utilizes elongate members such as angioplasty. Entry via femoral artery is most common, however, the site of entry may be at the brachial artery, the subclavian artery, or any other suitable anatomical point.

FIG. 2 shows an embodiment of a computer-assisted system for manipulating elongate members in a medical procedure.

FIG. 3 illustrates a block diagram of a computer system that can be utilized in association with embodiments of the invention.

FIGS. 4A and 4B show an embodiment of a module base that can be utilized to advance, retract, rotate, and retain elongate members.

FIG. 5 shows wheels that can be driven to advance or retract elongate members.

FIG. 6 shows a flow chart of a process of the initial placement of the guide catheter.

FIG. 7 shows a flow chart of a process of placing the guide wire at the desired destination.

FIG. 8 shows a flow chart of a process of utilizing interventional catheters.

FIG. 9 shows a drum that can be utilized to retract one elongate member while maintaining the position of one or more other elongate members.

FIG. 10 shows a flow chart of a process of retracting an interventional catheter.

FIGS. 11A and 11B show another embodiment of a module base that can be utilized to advance, retract, rotate, and retain elongate members.

FIG. 12 shows another embodiment of a computer-assisted system for manipulating elongate members in a medical procedure where the module base moves on rails in a helical arrangement.

FIG. 13 shows a screen image of a menu where a user can select the mode for manipulating the elongate members.

FIG. 14 shows the side view of the micro-positioning linear and torquing device from the side opposite the torquing motors.

FIG. 15 shows the side view of the micro-positioning linear movement and torquing device on the same side as the torquing motors.

FIG. 16 illustrates the coaxial telescoping mechanism for containing the guide wire.

FIG. 17 shows a side view of the linear-movement and torquing motors.

FIG. 18 shows the top view of one embodiment of a control mechanism.

FIG. 19 shows the top view of an alternative control mechanism.

FIG. 20 shows the side view of the alternative control mechanism.

FIG. 21 shows a schematic diagram of the components used in the alternative control mechanism.

FIGS. 22A, B Front stage of linear-configuration embodiment for maneuvering elongate members.

FIGS. 23A-C Detail of front-stage components of linear configuration.

FIG. 24 Overview of combined front and rear stages of linear configuration.

FIG. 25A Detail of back of rear stage of linear configuration.

FIG. 25B Detail of front of rear stage of linear configuration.

FIG. 26 TurboTorquer embodiment in linear configuration.

FIG. 27 shows a haptic mechanism for measuring backward pressure within the course of the catheter or guide wire.

FIG. 28 illustrates a mechanism for measuring force back on the catheter or guide wire by measuring the force back on the drive mechanism.

FIG. 29 shows a mechanism for measuring force feedback at the tip of the catheter or guide wire.

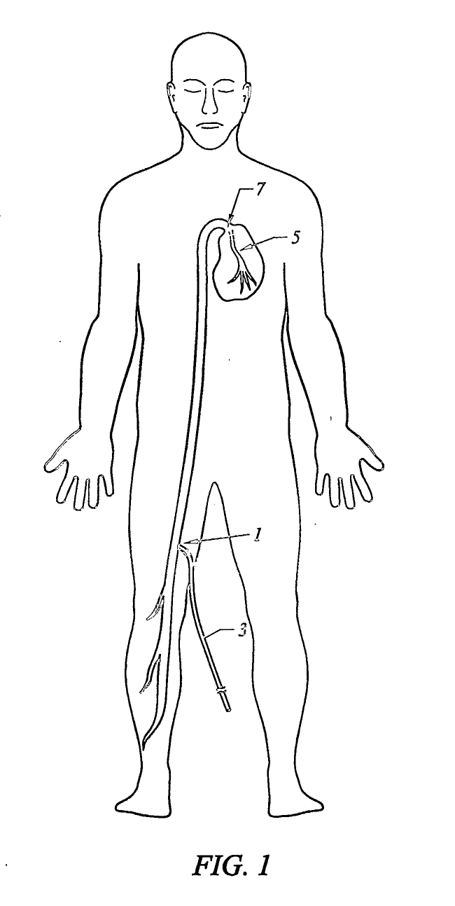

### DETAILED DESCRIPTION OF PREFERRED EMBODIMENTS

In the description that follows, the present invention will be described in reference to embodiments that utilize computers and electromechanical devices to manipulate elongate members such as catheters and guide wires. More specifically, the embodiments will be described in reference to preferred embodiments. However, embodiments of the invention are limited to any particular configuration, architecture, or specific implementation. Therefore, the description of the embodiments that follows is for purposes of illustration and not limitation.

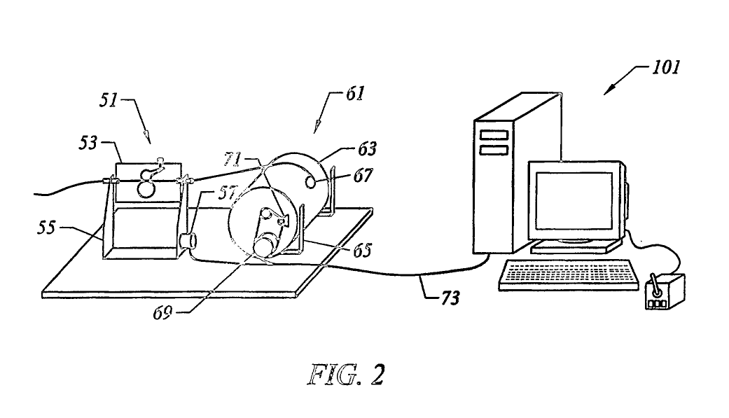

FIG. 2 shows a system of one embodiment of the invention that provides computer-assisted manipulation of elongate members in medical procedures. A module base assembly 51 is proximal to the patient and allows for advancement, retraction, rotation, and retention of elongate members. Module base assembly 51 includes a module base 53 that is supported by a stand 55.

Module base 53 may be rotated along the axis of the elongate members and can be driven by a stepper motor 57. Motor 57 can be coupled to module base 53 for driving rotation utilizing a belt, chain, worm gear drive or similar components. A gearbox may be interposed between the stepper motor and the gear that rotates the module base.

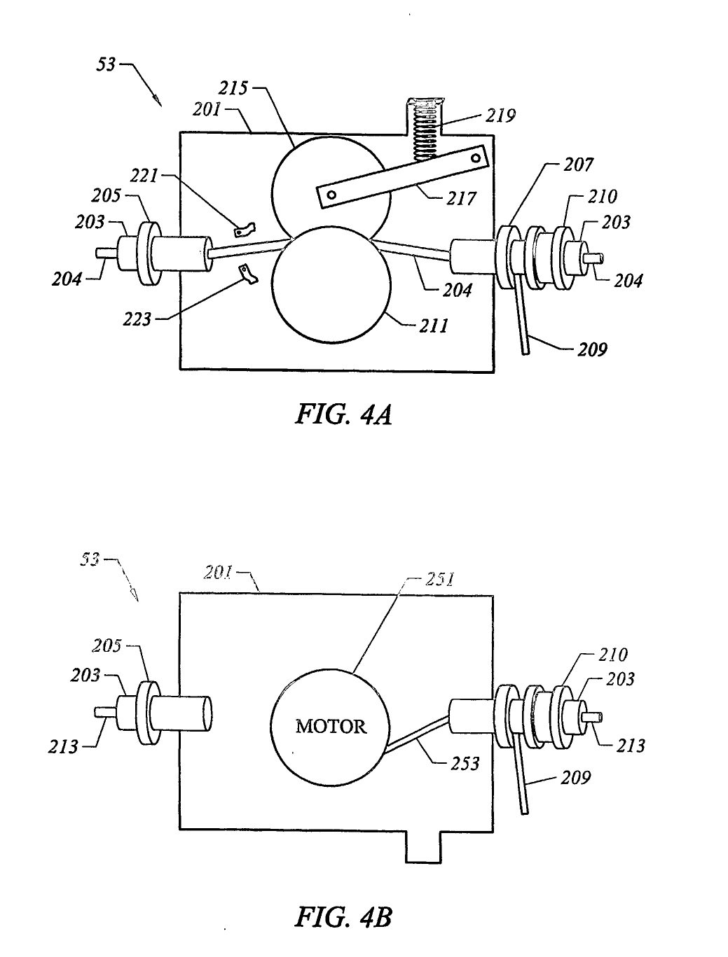

Module base 53 includes a motor and at least one wheel for advancing or retracting the elongate members. A specific embodiment of module base 53 will be described in more detail in reference FIGS. 4A and 4B.

A drum assembly 61 can be utilized to advance or retract a flexible elongate member while maintaining pressure on one or more other elongate members so that they stay in their current and desired location. Drum assembly 61 includes a drum 63 that is supported by a stand 65. A wheel (or spool) 67 is located on drum 63 and can advance or retract elongate members. Wheel 67 can be driven by a motor that is positioned inside drum 63 (not shown).

Drum 63 rotates along an axis that is perpendicular to the elongate members. Accordingly, when drum 63 rotates, elongate members that are attached to the drum can be advanced or retracted. Rotation of the drum can be driven by a motor 69 utilizing a belt as shown. Additionally, a biasing mechanism 71 can be attached to stand 65 in order maintain the proper tension of the belt. Alternatively, motor 69 can drive the drum via chain, worm drive, or other standard drive components, with or without an interposed gearbox.

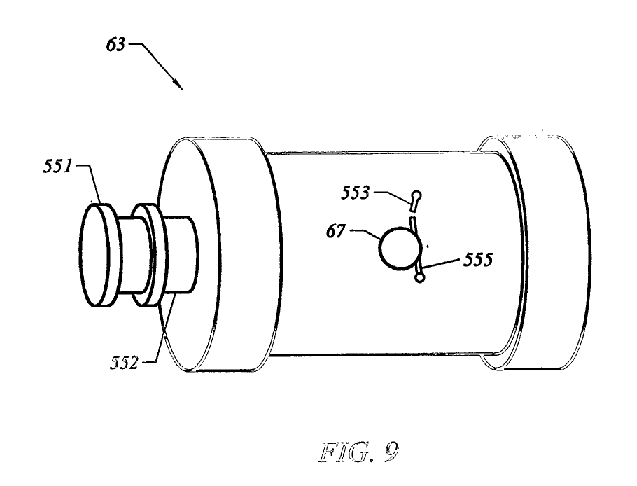

Although drum assembly 61 can be directed by the computer system to operate in many different ways, drum assembly 61 can be utilized to retract an elongate member while maintaining the other elongate members at their current locations. For example, the elongate member to be retracted can be secured to drum 63, which is then driven to retract the elongate member. At the same time, wheel 67 can be driven advance one or more other elongate members, for example a guide wire, so that they stay at their current desired location. More details on a specific embodiment of drum 63 will be described in more reference to FIG. 9.

Wires 73 connect the various electromechanical devices to a computer system 101. Computer system 101 is directed by a user and then utilizes electrical signals in order to control the electromechanical devices. The user can direct computer system 101 through common types of input such as a keyboard and a pointing device (e.g., joystick as shown, mouse, trackball, and the like). In addition to continuous movement, a mode of operation can be included to individually step or “bump” the controlled device or devices in movements of very fine resolution or granularity. This may be done in a rapid “hammering” fashion, or slowly and gently, in accordance with the needs for member advancement or retraction. Thus, the operator can achieve greater control than he or she would have while using traditional manipulation techniques.

FIG. 2 shows module base assembly 51 drum assembly 61 and computer system 101 that are capable of providing computer-assisted manipulation of elongate members during medical procedures. However, systems of the invention are not limited by the number of components. For example, a system can include fewer components, like module assembly 51 and computer system 01 or drum assembly 61 and computer system 101. Additionally, other embodiments can utilize additional components. For example, a system can include two (or more) module base assemblies similar to the one show in FIG. 2. In this manner, a first module base assembly can manipulate (e.g., advance, retract, rotate, or retain) one elongate member while a second modular base assembly manipulates a second elongate member. Thus, with two module base assemblies, the guide catheter and guide wire could both be manipulated simultaneously.

In an alternative embodiment, a stepper motor-driven rotation system located on the module base can drive the rotation of an individual device member. In yet another embodiment, linear actuators upon which gripper mechanisms are attached servers to grasp each wire or catheter, move it to the end of that linear actuator's travel, release their grip on the wire or catheter, return to their opposite extreme position, re-grip the wire or catheter, and begin another step of moving the wire or catheter to its intended location. The physical shape and layout of the member-driving apparatus may also be cantilevered; securely attached to the side of the operating table or other platform, and extending over the top of the patient's body. Such a configuration may be desirable in order to facilitate the introduction of catheters and wires at selected entry points to the body.

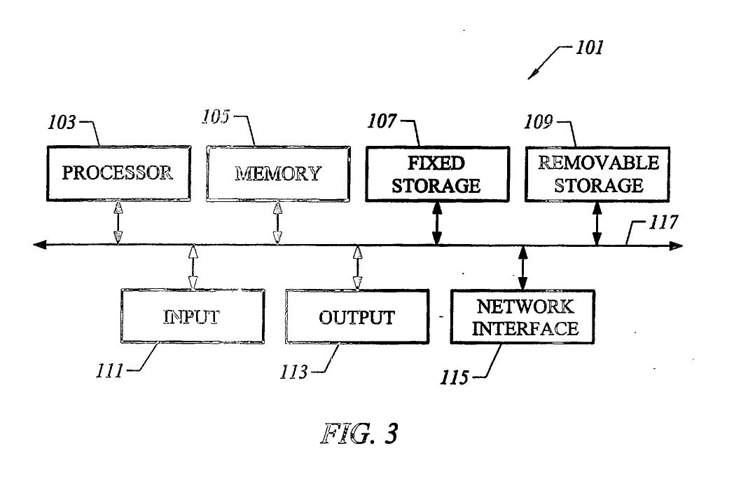

FIG. 3 shows a block diagram of components that can be present in computer systems that implement embodiments of the invention. A computer system 101 includes a processor 103 that executes instructions from computer programs (including operating systems). Although processors typically have memory caches also, processor 103 utilizes memory 105, which can store instructions (or computer code) and data.

A fixed storage 107 can store computer programs and data such that it is typically persistent and provides more storage when compared to memory 105. A removable storage 109 provides mobility to computer programs and/or data that are stored thereon. Examples of removable storage are floppy disks, tape, CD/ROM, flash memory devices, and the like.

Memory 103, fixed storage 107 and removable storage 109 provide examples of computer readable storage media that can be utilized to store and retrieve computer programs incorporating computer codes that implement the invention, data for use with the invention, and the like. Additionally, a data signal embodied in a carrier wave (e.g., in a network including the Internet) can be the computer readable storage medium. An input 111 allows a user to interface with the system. Input can be done through the use of a joystick, keyboard, a mouse, buttons, dials, or any other input mechanism. An output 113 allows the system to provide output to the user. Output can be provided through a monitor, display screen, LEDs, printer or any other output mechanism.

A network interface 115 allows the system to interface with a network to which it is connected. The system bus architecture of computer system 101 is represented by arrows 117. The components shown in FIG. 3 can be found in many computer systems. However, components can be added, deleted and combined. For example, fixed storage 107 could be a file server that is accessed through a network connection. Thus, FIG. 3 is for illustration purposes and not limitation.

FIGS. 4A and 4B show an embodiment of the module base that can manipulate one or more elongate members. A plate 201 serves as the foundation for other components. Two pipes 203 are attached on opposing ends of plate 201. One or more elongate members 204 pass through the lumen of pipes 203.

Plate 201 rotates about an axis provided by pipes 203. A rotating member 205 is coupled to one of pipes 203. A slip ring connector 207 is coupled to one of pipes 203, allowing electrical signals to be sent to electromechanical devices on plate 201 over one ore more wires 209, such that as plate 201 rotates, the one or more wires 209 do not coil up on pipe 203.

In an alternative embodiment, pipe 303 may be present only on the right (proximal) side of plate 201, thus allowing plate 201 to be shorter, and for wheel 211 to be closer to the site of elongate member entry into the body, thus requiring less elongate member length.

Pulley 210 is coupled to pipe 203 as shown. Referring back to FIG. 2, motor 57 drives a belt that is in contact with pulley 210 in order to rotate plate 201.

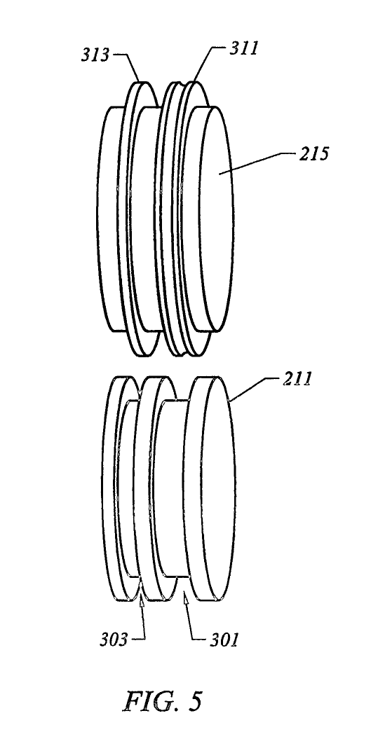

A wheel 211 is rotateably coupled to plate 201. Wheel 211 has one or more grooves for accepting elongate members 204 so that they can be advanced or retracted depending on the rotation of wheel 211. Wheel 211 is driven by a motor that is positioned on the other side of plate 201 and will be described in more detail in reference to FIG. 4B. Additionally, more details on wheel 211 will be described in reference to FIG. 5.

A wheel 215 is utilized to maintain friction between wheel 211 and elongate member 204. As shown, wheel 215 rotates on a fulcrum 217 and is biased against wheel 211 by a spring 219. Although this biasing mechanism is shown, other biasing mechanisms may be utilized. More details on wheel 215 will also be described in relation to FIG. 5.

Clips 221 and 223 allow for an elongate member to be retained on plate 201. In other words, the clip can be utilized to hold the elongate member so that it will not be advanced or retracted. Clips 221 and 223 can be of different sizes in order to retain different types of elongate members.

These clips, and other forms of releasable fixation devices, may be operated manually or may be operated via motorized remote control. For example, the catheter or wire may be releasably fixed at a certain point by the activation of a solenoid or electromechanical gripper, as is known in the art. The activation of this solenoid or gripper may be mediated by the software and activated by direct designation on the interface, the joystick, associated buttons, or automatically as part of entering one of several movement modes provided by the software, or automatically upon the completion of specific movement sequences. Alternatively, the closing and opening of a solenoid-based clip may be accomplished by the direct, manual action upon an electrical switch.

FIG. 4B shows the opposite side of plate 201 from FIG. 4A. As shown, a motor 251 is coupled to plate 201 opposite wheel 211. Electrical signals passed to motor 211 through one or more wires 253.

As shown, module base 53 in FIGS. 4A and 4B allow for elongate members to be advanced, retracted, rotated, and retained. The elongate members can vary in size so it may be beneficial to describe embodiments of wheel 211 and bias wheel 215 that accommodate elongate members with varying diameters. FIG. 5 shows a side view of wheel 211 and bias wheel 215 shown in FIG. 4A. Some elongate members like the guide or interventional catheters have a greater diameter than the guide wire. Elongate members with larger diameters can be threaded through a larger groove 301 on wheel 211. Bias wheel 215 has a corresponding structure 311 that includes a groove such that when bias wheel 215 is pressed against wheel 211, friction is maintained between the elongate member and wheel 211.

An elongate member with a smaller diameter can be placed in a smaller groove 303. A corresponding structure 313 on bias wheel 215 helps maintain friction between the elongate member and wheel 211 when bias wheel 215 is biased against 211. The specific grooves and other mechanisms for maintaining friction on the elongate members can be varied in other embodiments. The friction of wheel 211 against the elongate member causes the elongate member to be moved in accordance with the movement of wheel 211. This also applies when wheel 211 is rotated perpendicular to its normal axis of spin. Friction may be increased by increasing spring tension, by using multiple wheels 211 in series, multiple bias wheels 215 in series, and by using caterpillar treads between wheel 211 and another active or passive wheel that moves in tandem with wheel 211.

The elongate members can be flexible or rigid. Many examples of flexible members have been described. Additionally, the invention can be advantageously applied to manipulate rigid members, such as biopsy needles. Therefore, the invention is not limited by the specific embodiments shown.

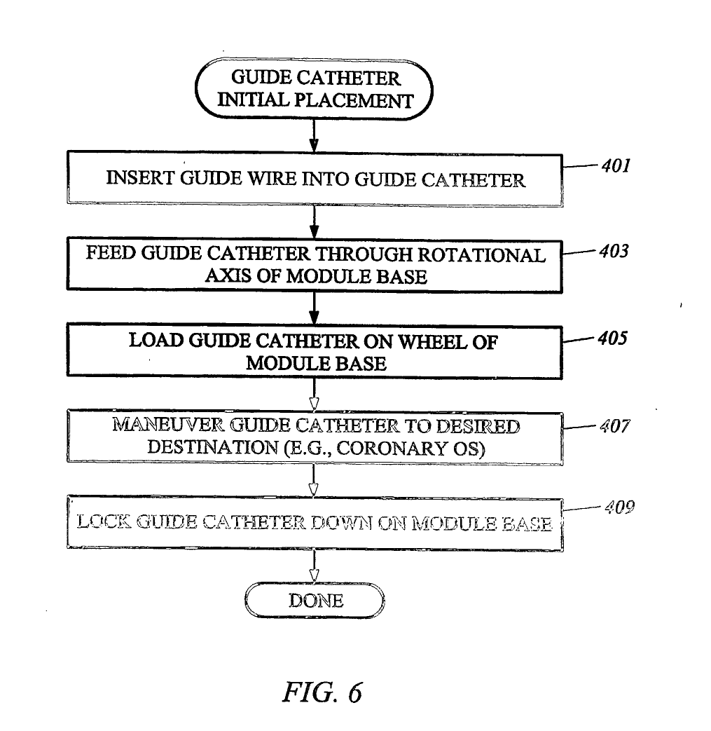

Now that embodiments of an overall system have been described, it may be beneficial to describe procedures utilizing the system. FIG. 6 shows a flow chart of a process of the initial placement of a guide catheter. As with all flow charts shown herein, steps may be added, deleted, combined, or reordered without departing from the spirit and scope of the invention. At a step 401, the guide wire is inserted into the guide catheter. Typically, the guide catheter has a slightly bend end that allows it to be maneuvered into the desired destination. For example, as described above, the guide catheter can be maneuvered to the coronary os.

The guide catheter is fed through the rotational axis of the module base at a step 403. Referring back to FIG. 4A, the guide catheter can be inserted into pipes 203.

At a step 405, the guide catheter is loaded on the wheel of the module base. Once again, referring back to FIG. 4A, wheel 215 can be retracted so that the guide catheter can be placed in groove 301 on wheel 211. At this point, the guide catheter can be maneuvered utilizing computer-assisted control to the desired destination within the patient.

The guide catheter is maneuvered to the desired destination at a step 407. A pointing device can be utilized to advance, retract, and rotate the guide catheter as it is maneuvered to the desired destination, such as the coronary os (or opening). For example, on a joystick, “forward” can advance, “backward” can retract and “left/right” can rotate in the respective direction. As is common in the art, imaging modalities such as fluoroscopy, ultrasound, real-time computerized tomography, or magnetic resonance imaging can be utilized to assist the user in maneuvering the guide catheter.

Once the guide catheter has reached the desired destination, the guide catheter is locked down on the module base at a step 409. For example, clip 221 shown in FIG. 4A can be utilized to retain the guide catheter on plate 201. Clip 221 should be placed near the end of the guide catheter so that module base 53 can be utilized to maneuver the guide wire or interventional catheter. As mentioned before, a second (or multiple) module base assembly can be utilized to independently maneuver one or more elongate members.

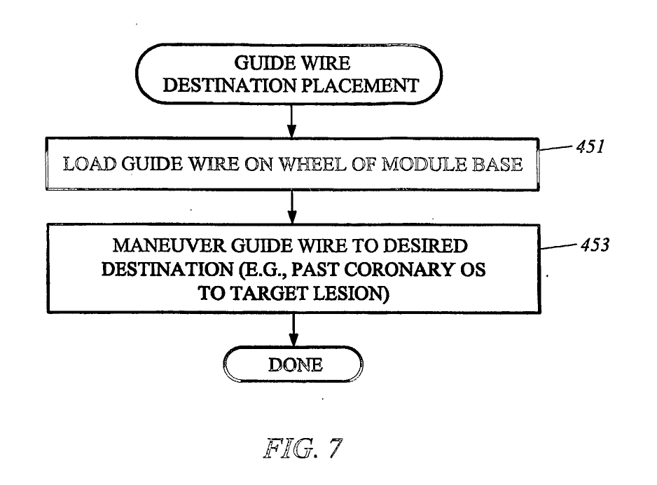

FIG. 7 shows a flow chart of a process of placing the guide wire at the desired destination. At a step 451, the guide wire is loaded on the wheel of the module base. Referring to FIG. 4A, wheel 215 may be retracted to allow the guide wire to be loaded in groove 303 of wheel 211.

The guide wire is maneuvered to the desired destination at a step 453. For example, module base 53 can be directed to maneuver the guide wire from the coronary os to the target lesion. Now that the guide wire is at the desired destination and the interventional catheter can be utilized to complete the medical procedure.

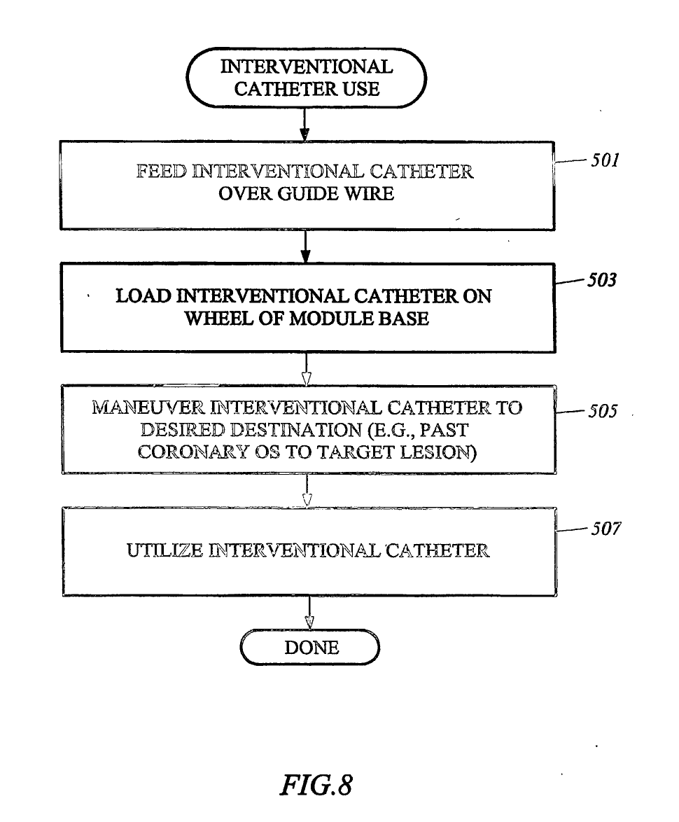

FIG. 8 shows a flow chart of a process of utilizing an interventional catheter. The interventional catheter basically is fed over the guide wire and within the guide catheter. The interventional catheter is loaded on the wheel of the module base at a step 503. The module base will be utilized to maneuver the interventional catheter to the desired destination.

At a step 505, the interventional catheter is maneuvered to the desired destination. For example, typically the interventional catheter is maneuvered through the guide catheter to the coronary os and then follows the path set out by the guide wire to the target lesion.

The interventional catheter is utilized at a step 507. As described above, the interventional catheter can be an angioplasty catheter that inflates a balloon or a stent catheter that inserts a stent. Other types of interventional catheters can also be advantageously utilized with embodiments of the present invention.

In many medical procedures of this type, it may be beneficial to swap out the interventional catheter being utilized. One of the disadvantages of prior techniques is when an interventional catheter is retracted, the friction on the other elongate members can result in the other elongate members (e.g., guide catheter) being retracted away from their desired destination. Drum assembly 61 can be utilized to reduce or eliminate the possibility of this occurrence.

FIG. 9 shows the drum of the drum assembly. The drum can be rotated about its axis by a motor that drives a belt that is coupled to pulley 552. Alternatively, the apparatus may be driven by a chain or worm gear, with or without an interposed gearbox. A slip ring electrical connector (with no bore hole) 552 allows electrical connections to pass to and from rotating drum 63.

Drum 63 includes a clip 553 for retaining elongate members, such as an interventional catheter. As with the clips described previously, these releasable fixation devices maybe electronically activated. As described above, wheel 67 is driven by a motor that is located within the drum (not shown). Wheel 67 can operate as a spool that stores an elongate member such as the guide wire, or may simply pull wire behind it, in the manner of wheel 211 Regardless, wheel 67 can act to advance or retract an elongate member and a biasing member 555 can be utilized to maintain friction wheel 67 and the elongate member. As shown, biasing mechanism 55 is a strip of spring steel metal that is biased against wheel 67. Optionally, a bias wheel like bias wheel 211 may be used as the method for keeping the elongate member in fictional contact with the drive mechanism. In an alternative embodiment, a small hole may be provided through the surface of drum 63 so that the tail end of wire retracted by wheel 67 can coil itself in the hollow interior drum 63. Other containers affixed to the drum may also be used to hold the tail end of the guide wire.

As will be described below, drum 63 can be rotated to retract a first elongate member while wheel 67 is directed advance a second elongate member. This allows the first elongate member to be retracted without moving the second elongate member from its desired location.

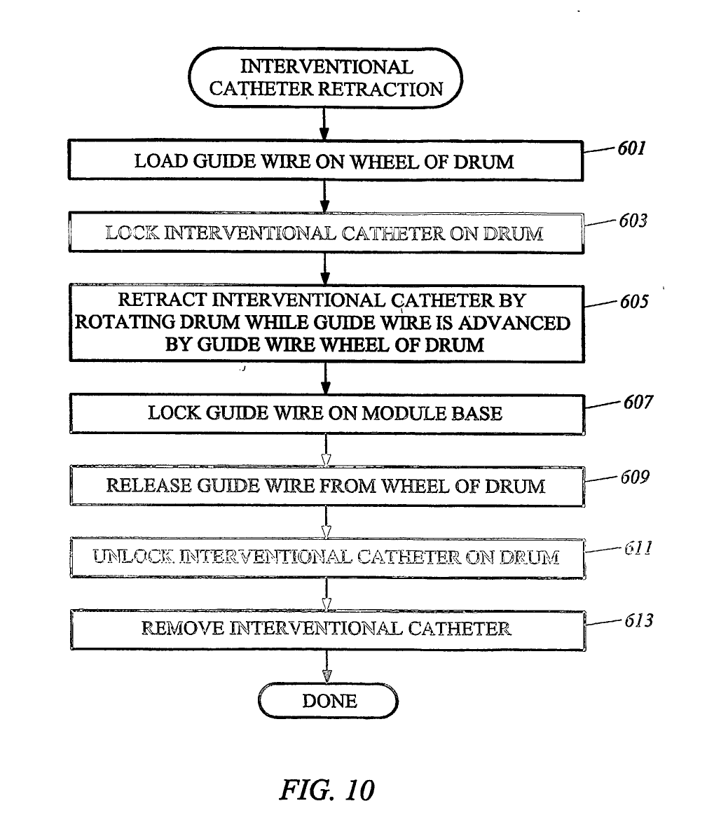

Now that drum 63 has been described in more detail, it may be beneficial to describe how the drum assembly can be utilized to retract an interventional catheter. FIG. 10 shows a flow chart of a process of retracting an interventional catheter

At a step 601, the guide wire is loaded on the wheel of the drum. Referring back to FIG. 9, the guide wire is loaded on wheel 67 of drum 63. When wheel 67 is rotated backwards, the guide wire will spool up on wheel 67, or be driven into the interior of the drum, or drum-associated container, so that when drum 63 rotates, the distal portion of the guide wire will not be in the way. If wheel 67 is not engaged, or if the drum does not need to be rotated, the guide wire may be left to freely trail over and behind the drum.

The interventional catheter is then locked on the drum at step 603. For example, the interventional catheter can be retained on the drum utilizing clip 553.

At step 605, the interventional catheter is retracted by rotating the drum while the guide wire advanced by the wheel of the drum. When the user instructs the computer system to retract the interventional catheter, motor 69 directs rotation of drum 63 to retract the interventional catheter while at the same time the motor coupled to wheel 67 is directed to advance the guide wire. As wheel 67 is coupled to drum 63, the rotation of drum 63 acts to retract the guide wire. However, the rotation of wheel 67 advances the guide wire and is preferably controlled so that the advancement counters the retraction of the guide wire so that the guide wire stays at the desired location.

The guild wire on wheel 67 may be advanced through the guide catheter or interventional catheter without buckling, provided that the opening to the guide catheter or interventional catheter is held firmly in place by clip 553 and in close proximity to the exit of the path from wheel 67 and clip 553. This ability to maintain the guide wire in place, despite the retraction of adjacent or surrounding members, may be very advantageous since threading it through a region of blockage can be a delicate procedure and one that one would preferably not want to repeat.

Once the interventional catheter is retracted past or to module base 53, the guide wire is locked down on the module base at a step 607. For example, clip 223 on plate 201 can be utilized to retain the guide wire.

At a step 609, the guide wire can be released from the wheel of the drum. For example, wheel 67 can be rotated to unspool the guide wire from wheel 67, or to drive it forward from its extended or coiled resting point behind wheel 67.

The interventional catheter can be unlocked on the drum at a step 611. For example, the end of interventional catheter can be released from clip 553 on drum 63. Now, the interventional catheter can be removed at a step 613 by pulling it off the guide wire.

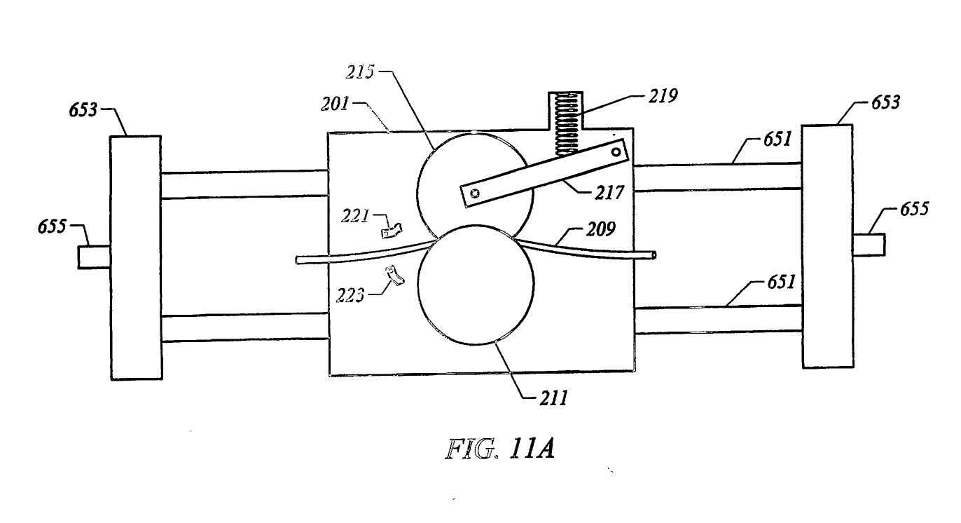

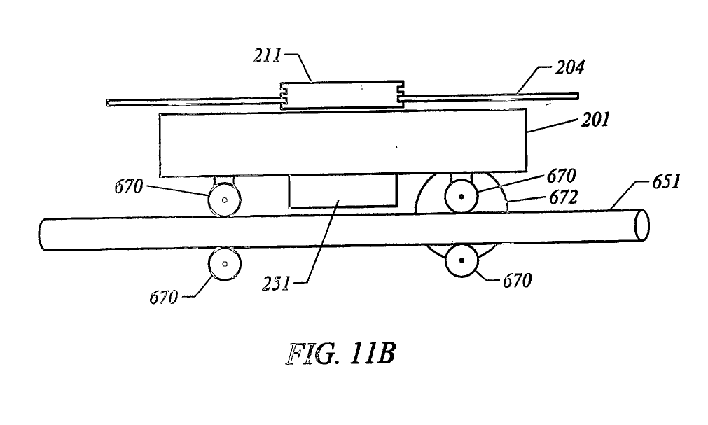

FIG. 11A shows another embodiment of a module base. The module base is similar to what is shown and described in reference to FIGS. 4A and 4B. However, in this embodiment, module base 201 is movably mounted to two rails 651. The rails are held stable by two end plates 653. The assembly shown in FIG. 11B can be rotated by a motor and pivot about end points 655.

The module base moves along rails 651 as shown in FIG. 11B. Wheels 670 ride on rails 651 and are biased against the rails in pairs as shown. In order to drive module base to advance or retract, a motor 672 drives one of the wheels.

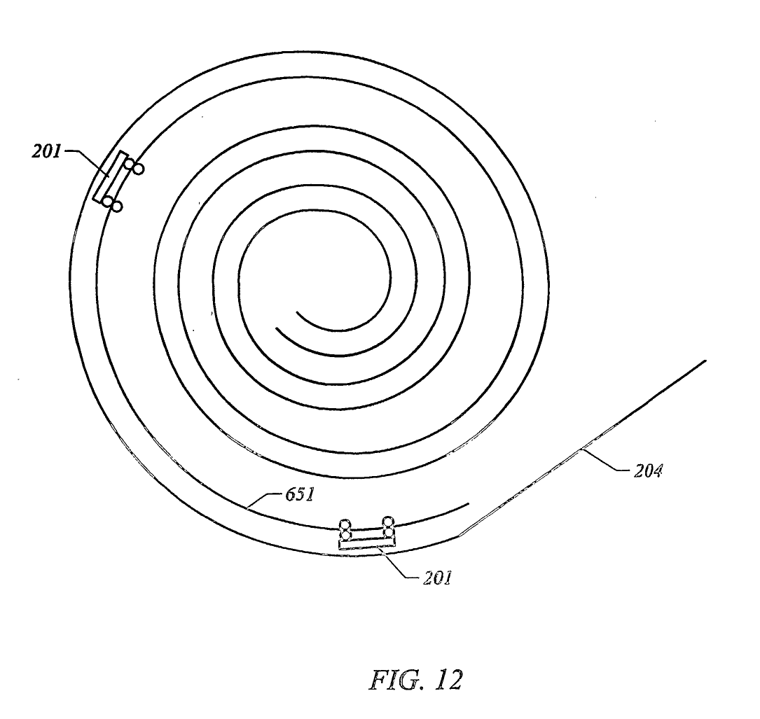

A system that utilizes the module base assembly shown in FIGS. 11A and 11B can be utilized in a manner similar to what has been described above. If it is desirable to reduce the size of the system (e.g., the rails may extend several feet or more), an embodiment can be utilized as shown in FIG. 12.

FIG. 12 shows another embodiment of a computer-assisted system for manipulating elongate members in a medical procedure where the module base moves on rails in a helical arrangement. Rails 651 are coiled in a helical (or nautilus) arrangement. One or more module bases 201 can be directed by a computer system to move along the rails, advance or retract elongate member 204, and the like. In order to rotate elongate member 204, the entire helical structure can be rotated by a motor. Alternatively, the drive wheel on each module base may be independently rotated, for example, by additional, module-base-specific step motors.

As described above, a user can utilize a pointing device to direct manipulation of the elongate members. A graphical user interface can also be utilized to direct the operation of the system.

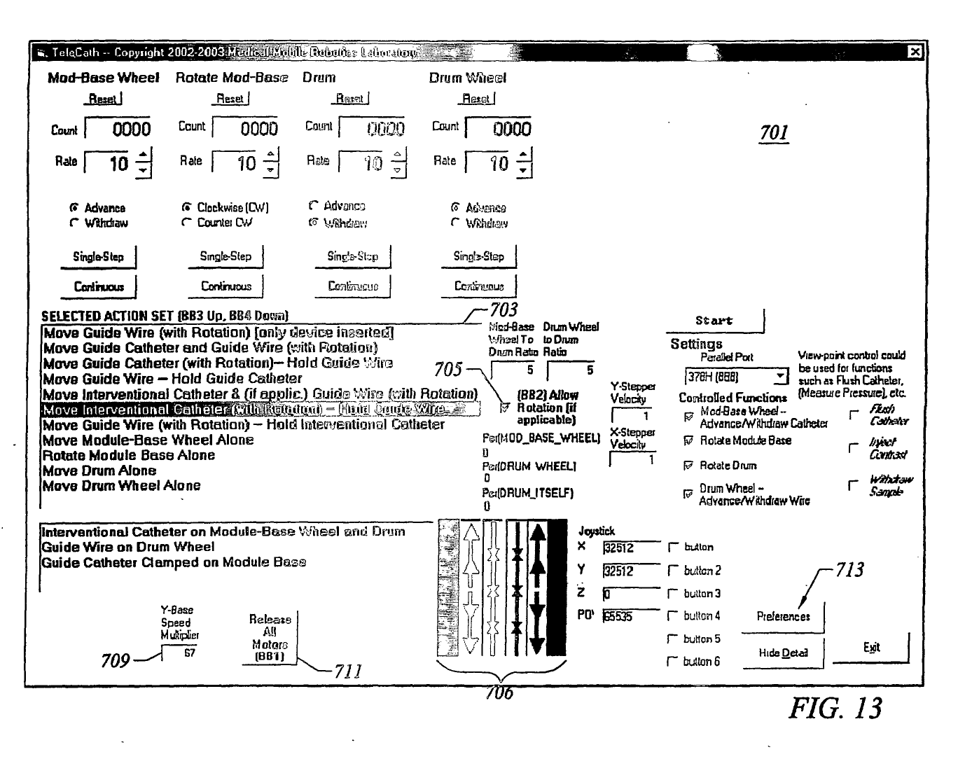

FIG. 13 shows an example of a graphical user interface menu that directs the operation of the system. A window 701 includes a menu 703. Menu 703 allows the user to select the operational mode of the system, including which the axes of movement are to be active and under control of the joystick at any given time. A mode dictates which motors on the apparatus will be active concurrently, in which direction they will move, and at what relative speeds. For example, the selection that has been made directs the system to move the guide catheter and guide wire with rotation.

In one embodiment, the mode can be selected by pressing buttons on a joystick base. Another method can be to select the desired mode on the screen by positioning a cursor with a pointing device such as a mouse, track pad, track ball, or the like, and selecting with a button click.

The operator can be informed as to the type or types of motion anticipated in the various modes by a graphic area 706 displayed on a portion of the screen, with the graphics changing depending on which mode is selected. For example, such a graphic may include a longitudinal cross-sectional diagram of a guide catheter with an interventional catheter and a guide wire within. Figures such as arrows (for motion) and X's (for stasis) may be graphically superimposed upon the appropriate parts of the cross-sectional diagram, thus showing what elements will be moved and what elements will remain still at each selected motor combination mode.

A check box 707 allows a user to specify whether to allow rotation in a selected mode if it is applicable. A text window 707 shows the current status of the system. A user is able to enter a speed multiplier in text box 709. This speed multiplier, in conjunction with direction and speed input information output by switches and the angular displacement of the joystick, will affect the speed at which the elongate members are manipulated, such as advanced and retracted.

In one embodiment, the speed of stepper movement is proportional to the deviation (or movement) from neutral of the joystick handle (or other pointing device). Small deviations from neutral may be ignored in order to promote stability, ease of use, and to prevent accidental movement triggering. Setting the differential speed between the various motorized components is a function that is governed by the controlling software and is advantageous for providing coordinated actions.

A button 711 allows all the motors to be released. By releasing the motors, the elongate members in contact with the wheel, which are coupled to the motors, will provide minimal resistance to the elongate members. This may be accomplished in order to facilitate changing catheters and wires in and out of the various drive mechanisms. A button 713 allows a user to specify preferences for the system. Alternatively, or in addition to, physical buttons on the joystick may be used to set preferences for the system, including stepper combination mode, speed, stepper release, etc.

In one embodiment, the TurboTorquer, the combined linear and torquing movements are performed using a linear motor gear box running on a threaded rod to which is attached a torquing motorized gear drive that holds the guide wire. The advancing and withdrawing movements of the linear maneuver is controlled by one pair of switches while the clockwise and counter-clockwise rotation of the torquing maneuver is controlled by a second pair of switches.

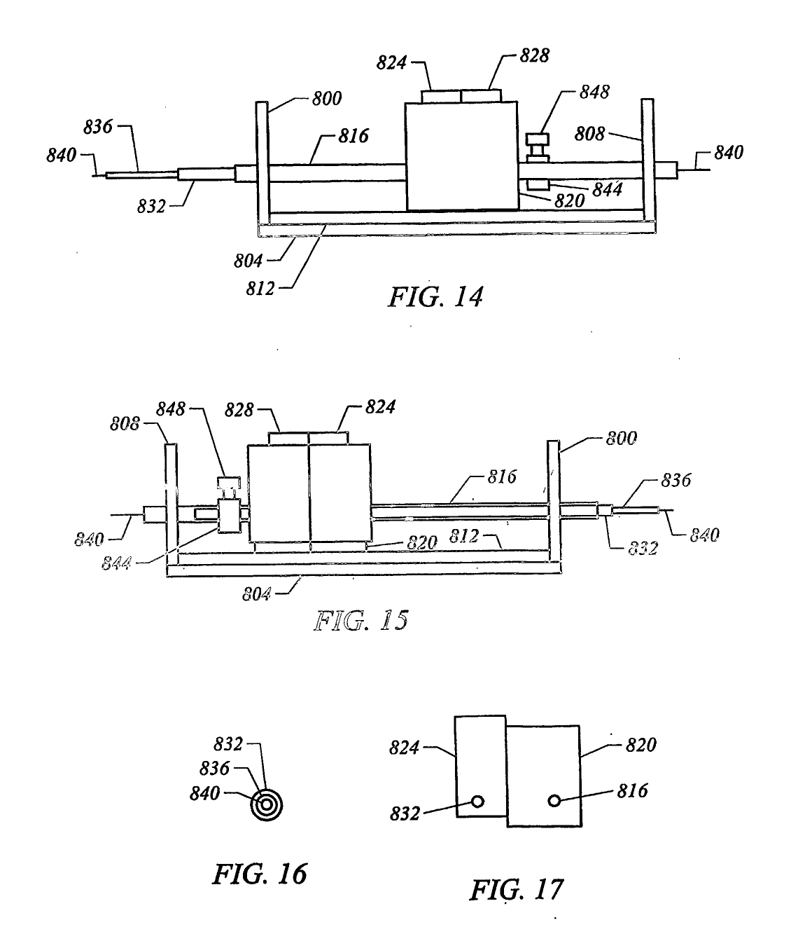

The objective of the linear-movement and torquing micro-positioning is to move guide wire 840 as shown in FIG. 14 which shows the overall assembly from the side containing the linear-motion motor gear box 820. The frame for the linear-movement and torquing micro-positioning device consists of the three members 800, 804, 808 that can be fabricated from a bent metal piece or cast in plastic. The flat metal or plastic component 812 serves to strengthen the assembly as well as provide a smooth surface on which the bottom surface of the case of the linear-movement motor-gear box 820 moves. Movement of 820 is accomplished by its running along a fixed 6-32 threaded rod 816. An embodiment of the motor gear-box drive for the linear-movement component is the Tamiya 4-Speed Crank Axle Gearbox, Tamiya Item 70110 (Tamiya, Inc. 3-7 Ondawara, Hizuoka-City, Japan). This drive was constructed with a gear ratio of 126:1. This motor drive was modified by threading the hole is the metal drive gear with a 6-32 thread so it can run back and forth along the fixed 6-32 threaded rod 816. The guide wire 840 is held in the torquing assembly which consists of a gear-box with twin motors 824 and 828 turning hollow shaft 832 which has a collar 844 with a threaded set screw combined with a knurled knob 848 which, when screwed in grips guide wire 840 so it can be torqued or moved linearly. The torquing assembly (and thus attached guide wire 840) is moved linearly by the attachment of the twin-motors gear box with motors 824 and 828 to the linear-movement gear box 820. An embodiment of the twin-motor gear-box drive for the rotary component with motors 824 and 828 is the Tamiya Twin-Motor Gear Box, Tamiya Item 70097 (Tamiya, Inc. 3-7 Ondawara, Hizuoka-City, Japan). This drive was constructed with a gear ratio of 58:1, although the alternative of 203:1 would also be satisfactory if the appropriate drive voltage were used. This motor set was modified by replacing the hexagonal shaft supplied in the kit with a ⅛″ outside diameter brass tube 832 with two concentric coaxial brass tubes within. The first of these two tubes, 3/32″ outside diameter (not shown in FIG. 14), is used to decrease the diameter between the outer and the inner tubes and the inner tube 836, ⅛″ outside diameter, is the telescoping enclosure for the guide wire 840. The guide wire 840 is clamped by knurled-knob set screw 848 within the 3/32″ tube. Note that a single motor of sufficient power is a reasonable substitute for twin motors 824 and 828 or more motors can be used.

FIG. 15 shows the same components of FIG. 14, but this time from the side containing the torquing gear-box with twin motors 824 and 828. The frame for the linear-movement and torquing micro-positioning device consists of the three members 800, 804, 808 that can be fabricated from a bent metal piece or cast in plastic. The flat metal or plastic component 812 serves to strengthen the assembly as well as provide a smooth surface on which the bottom surface of the case of the linear-movement motor-gear box 820 moves. Movement of 820 is accomplished by its running along a fixed 6-32 threaded rod 816. The guide wire 840 is held in the torquing assembly which consists of a gear-box with twin motors 824 and 828 turning hollow shaft 832 which has a collar 844 with a threaded set screw combined with a knurled knob 848 which, when screwed in grips guide wire 840 so it can be torqued or moved linearly. The torquing assembly (and thus attached guide wire 840) is moved linearly by the attachment of the twin-motors gear box with motors 824 and 828 to the linear-movement gear box 820. Tube 836 is the telescoping enclosure for the guide wire 840. The guide wire 840 is clamped by knurled-knob set screw 848 within the 3/32″ tube 832.

FIG. 16 illustrates the telescoping tube mechanism with tube 832 being the outer tube into which the guide wire which runs through lumen 840 is clamped. The inner tube 836 telescopes into outer tube 832 so that the ongoing path for the guide wire running through lumen 840 can be fully contained until its destination (e.g., a Y connector of an angioplasty catheter) so it will not bend and thus make the linear and torquing movements ineffective.

FIG. 17 shows a side view of the driving gear boxes, the linear drive-motor gear box 820 with its shaft 816 being the 6-32 threaded rod and the front-most motor 824 of the twin-motor torquing motors with its shaft 832 containing the telescoping mechanism shown in FIG. 16 containing the guide wire (not shown).

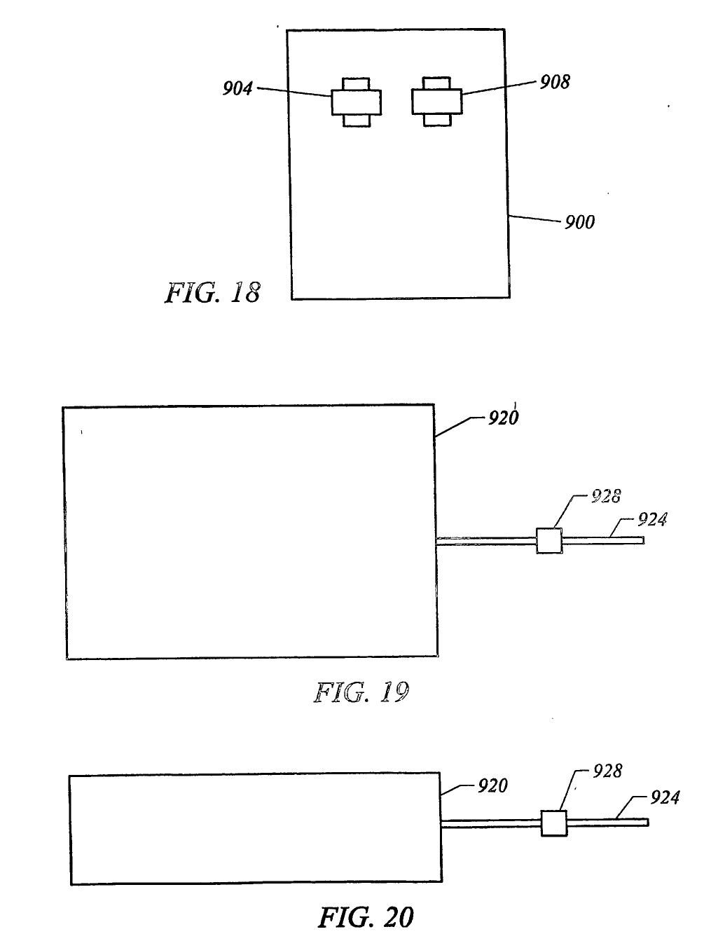

Multiple control mechanisms for the described electromechanical assemblies are possible. FIG. 18 shows an embodiment housed in enclosure 900 consisting of a pair of lever switches 904 and 908 which each lever switch is actually a combination of a pair of switch elements. One of the switches (say 904) when pushed up advances the carriage (and thus the guide wire) and when pushed down withdraws the carriage. The other switch (say 908) when pushed up rotates the wire holder clockwise (and thus the guide wire) and when pushed down rotates the wire holder counterclockwise. A commercially made example of such a control mechanism is the 2-Channel Remote Control Box, Tamiya Item 70102 (Tamiya, Inc. 3-7 Ondawara, Hizuoka-City, Japan).

An alternative embodiment is shown in FIG. 19. In this case, the maneuvers are analogous to what would be used by the operator operating in a manual mode. Thus the operator employs the same type of movements to control the micro-positioner as would be used when performing the same maneuvers manually. The switching mechanisms are housed in enclosure 920. The operator grasps a control rod 924 (that can be covered by a plastic covering if the rod is metal, for more of a catheter feel). Linear control is accomplished by moving the rod forward to advance the guide wire and backward to withdraw the guide wire. Torquing (rotational) control is accomplished by twisting/rotating the rod clockwise or counter-clockwise which causes the same movement of the wire being controlled. A knurled knob 928 can optionally be placed on the rod to make rotational movements easier. This is equivalent to placing a “torquer” device on a guide wire used manually. In addition, rod 924 can be bent downward to the right of the knurled knob 928 to make twisting actions easier. Compound movements such as advancing while torquing simultaneously can be performed. If advancing and torquing are done simultaneously, the result is a corkscrew motion.

FIG. 20 shows a side view of the switching box described in FIG. 19. In this case the enclosure is 920 and the control rod 924 has a knurled knob 928 to facilitate twisting motions.

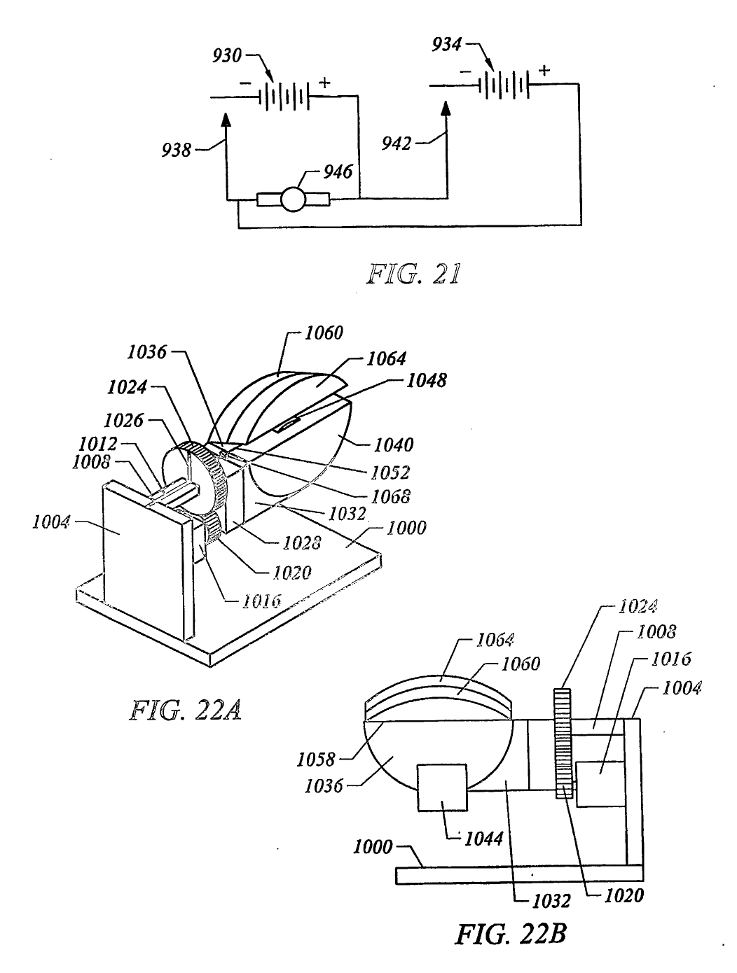

FIG. 21 illustrates the schematic diagram within the control-box enclosure 920 for each pair of movements: linear advance/withdrawal and torquing clockwise/counter-clockwise. The control-box enclosure 920 will contain components for two sets of the components shown in FIG. 21. If the components in FIG. 21 represent the linear advance/withdraw movements, a second set of components would handle the torquing clockwise/counterclockwise movements. The batteries providing the power are components 930 and 934 with their positive and negative poles marked. The voltages used are in the range of 1.5 to 6 volts depending on requirements of the motor 946. The motor 946 is not contained within the enclosure but is part of the TurboTorquer assemblies shown in FIGS. 14-17. The motor 946 may represent one or more motors. The pair of switches 938 and 942 used in each case is a pair of roller-lever micro-switches. For the linear mode, one roller-lever normally open switch 938 is closed when the control rod 924 in FIG. 19 is pushed towards the enclosure 920 and the other roller-lever normally open switch 942 is closed when the control rod 924 in FIG. 19 is pulled away from the enclosure 920. In neutral position or when the other switch of the pair has its normally open switch closed, a given switch is open. The advance/withdrawal motion is controlled by one such schematic shown in FIG. 21 and the torquing clockwise and counter-clockwise is controlled by another. A motor-speed control module could be added to the circuit by interposing it in the leads to the each motor (or pair of motors in the case of the twin-motor drive). One type of this device employs pulse width modulation (PWM) adjust the speed of the motor(s) over a range, for example, of 5% to 95% without incurring power loss through unnecessary heat dissipation.

An alternative embodiment that uses a linear configuration, instead of involving a drum, is shown in FIGS. 22-26. It is comprised of a front stage and a rear stage. Two views of the front stage are shown in FIGS. 22A and 22B. The front stage can be used stand alone or as part of a front stage/rear stage combination. On a stand-alone basis it is used to do diagnostic procedures or Electrophysiological (EP) procedures that use a single catheter (either a guide catheter or an EP catheter) as opposed to interventional procedures that employ two catheters (a guide catheter and an interventional catheter).

Two views, FIGS. 22A and 22B, show a perspective right-side view and a left-side view respectively so that the configuration of the front stage may be better appreciated. The base for the front stage consists of a horizontal component 1000 and a vertical component 1004. The medical device being driven (a catheter (possibly with a guide wire within its lumen) or a guide wire) is held within a clamshell, the body components of which are 1036 and 1040 for the lower clamshell and 1060 and 1064 for the upper clamshell. The clamshell configuration is used so that a medical device can be laid in the groove 1052 to be driven linearly by active drive-wheel disk 1048 turned by stepper motor 1044 and the top of the clamshell closed down on the bottom of the clamshell using hinge 1056 without requiring the medical device to be threaded through the drive mechanism. The upper and lower clamshell components are held closed by a set of magnets (not shown) embedded in 1060 and 1064 in the upper clamshell being attracted to a set of magnets (not shown) embedded in 1036 and 1040 in the lower clamshell. In addition to the linear driving of the medical device, rotation is provided as well. The clamshell is cradled in curved-edge block 1032. The rear face of 1032 is attached to rectangular block 1028, the rear face of which is in turn attached to the front of rotary gear 1024. The groove 1026 in gear 1024 allows the medical device to be driven to be laid down into its groove rather than threaded through a channel. Rotary gear 1024 rotates on half dowel 1008 with the medical device carried in groove 1012. Groove 1026 goes only down to the curved radius of half dowel 1008 to rotary gear 1024 can rotate. Horizontal movement of rotary gear 1024 on half dowel 1008 is prevented by pins (not shown) in rotary gear 1024 projecting into a groove (not shown) in half dowel 1008. Vertical movement of rotary gear 1024 is prevented because it sits on drive gear 1020 which is meshed with rotary gear 1024 and rotates rotary gear 1024 when drive gear 1020 is rotated by stepper motor 1016. When a guide wire needs to be firmly held in place, say for the exchange of interventional catheters when both the front and rear stages are used, clamp 1068 is employed.

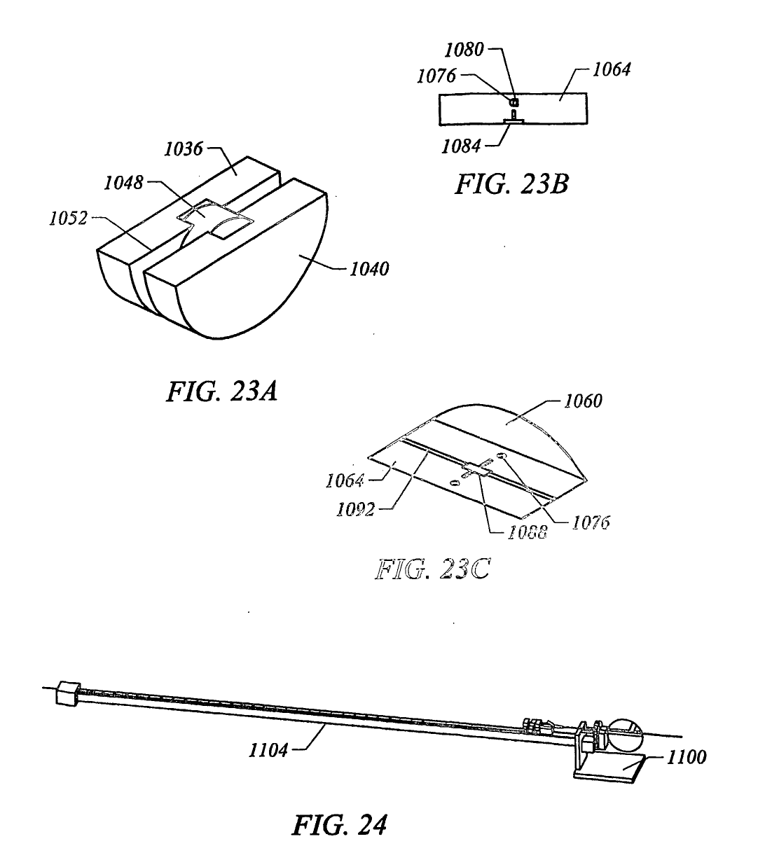

More detail of the upper and lower clam-shell assemblies is shown in FIGS. 23A-C. In FIG. 23A the right and left halves of the lower clam-shell body, 1040 and 1036 respectively, are separated so that active drive-wheel disk 1048 can be better viewed. Half of the groove 1052 is also indicated. FIG. 23B shows the bottom view of 1064, one half of the upper clamshell and FIG. 23C shows both halves of the upper clamshell viewed in perspective from the bottom. Each hole 1076 has a tension spring 1080 residing in it that pushes down on the passive tension disk 1088 that resides in opening 1084. The medical device being driven is contained within groove 1092. Passive tension disk 1088 presses the medical device being drive down on active drive-wheel disk 1048 as shown in FIG. 22A so the medical device can be driven linearly through groove 1052 or rotated through the turning of the closed clamshell when rotary gear 1024 is turned.

A typical procedure, say an EP procedure, using the front stage alone is as follows. The front-stage clamshell is opened and the catheter is laid in groove 1052 and through groove 1026 in rotary gear 1024 as shown in FIG. 22A. The front-stage clamshell is then closed. The catheter is linearly advanced (or retracted) by controlling the rotation of stepper motor 1044 shown in FIG. 22B. When rotation of the catheter is desired, the rotation of stepper motor 1016 is controlled with its attached gear 1020 which turns rotary gear 1024 clockwise or counter clockwise as needed. Since rotary gear 1024 is attached to the front-stage clamshell, the clamshell and thus the catheter is rotated as well. The catheter can be moved linearly and rotated simultaneously.

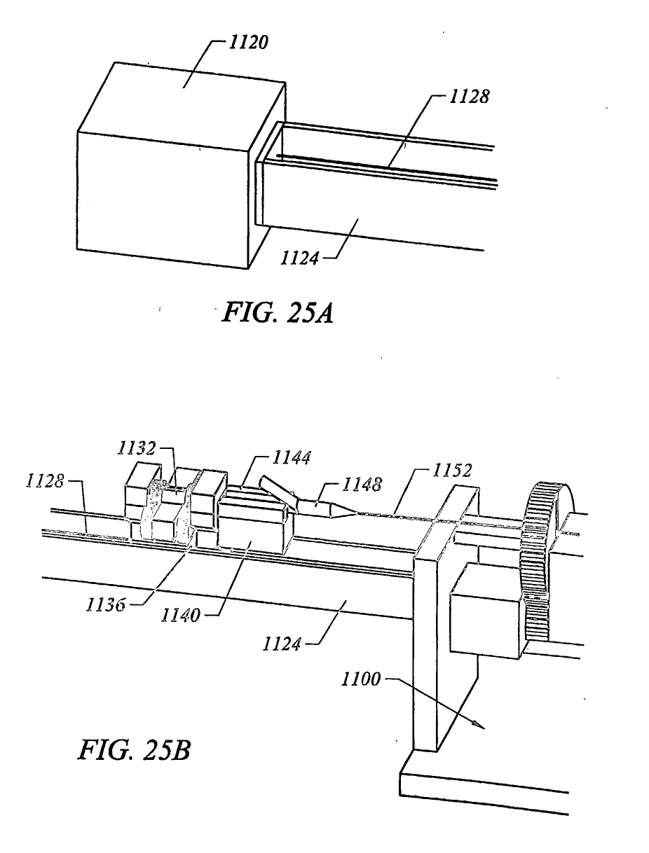

The combination of front and rear stages is shown in FIG. 24 with 1100 being the front stage and 1104 the rear stage. This configuration is used when the medical procedure involves an interventional catheter. The back portion of the rear stage is shown in FIG. 25A. The stepper motor 1120 turns threaded rod 1128 (say, for example, ½ inch in diameter) which is contained within channel 1124. Channel 1124 is long enough to permit the exchange of interventional catheters used in the interventional procedures being performed.

The front of the rear stage is shown in FIG. 25B. The front stage 1100 is included to show the physical relationship to the rear stage. The rear-stage components, the TurboTorquer 1132 and the interventional catheter assembly (comprised of interventional catheter 1152 with its Y connector 1148 held by clamp 1144 supported by block 1140) both ride on square support nut 1136 which is moved forwards and backwards on threaded rod 1128 as threaded rod 1128 is rotated by stepper motor 1120 shown in FIG. 25A. Square support nut 1136 is itself held in an upright position by the walls of the rear-stage rectangular channel 1124 that is open at the top.

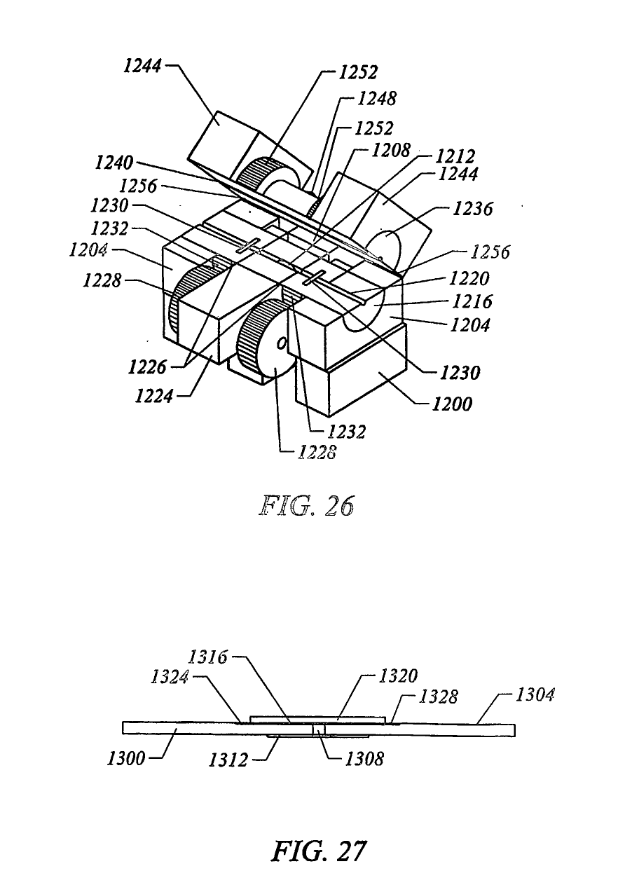

The detail of the TurboTorquer (1132 in FIG. 25B) is shown in FIG. 26. The TurboTorquer provides for fine motions, particularly of the guide wire on which the interventional catheter rides. As is done with the front stage of this embodiment, the TurboTorquer uses a clamshell approach to avoid having to thread the guide wire through a tube or clamp. In FIG. 26, the TurboTorquer is shown with its clamshell open. The upper clamshell is comprised of a half-dowel core 1236, end blocks 1244, half gears 1252 and a passive tension disk 1248, the shaft of which is pressed down by tension springs (not shown) at each end. The upper clamshell is connected to the lower clamshell by hinge 1256. A driven medical device runs through a groove comprised of upper-half groove 1240 in the upper clamshell and lower-half groove 1220 in the lower clamshell.

The lower clamshell is comprised of its half-dowel core 1216, end blocks 1204, half gears 1232 and active drive-wheel disk 1212 that causes the linear motion of the medical device contained in the TurboTorquer when driven by stepper motor 1208. The end blocks 1204 are attached to the E-shaped support block 1200 which in turn rides on square support nut 1136 as shown in FIG. 25B.

The upper and lower clamshells of the TurboTorquer are held closed by magnets (not shown) contained within the end blocks 1244 of the upper clam shell when the clamshell is closed and they are attracted by magnets (not shown) within the end blocks 1204 of the lower clamshell. When the clamshell is closed, the half gears 1252 of the upper clamshell meet with their matching half gears 1232 of the lower clamshell and can be rotated by rotary drive gears 1228 driven by stepper motor 1224 because the upper clamshell half-dowel core 1236 makes a complete dowel that can be rotated with the confines of the mated sets of end blocks 1244 and 1204 when 1236 is mated with its lower clamshell half-dowel core 1216. This rotation is possible while not rotating the segment of the dowel containing the linear active-drive wheel because each half dowel is split at dividers 1226 at the edge of the half gears 1252 and 1232. The three subcomponents of each half dowel are retained in alignment through use of a circular tongue and groove (not shown) mating the center part to each end part. When clamping for rotation is required, pressure clamps 1230 are activated. When simultaneous linear and rotary maneuvers are needed, the control mechanism provides for rapidly alternating clamping of 1230 and coincident rotation alternating with unclamping of 1230 and coincident linear drive.

A typical interventional procedure using the combined front and rear stages is as follows. A guide catheter is first place manually or by using the front stage as described previously. A guide wire is loaded in the interventional catheter and the interventional catheter threaded through the guide catheter using the front-stage mechanism in the same manner as described previously except the rotary movements are not needed since the path is determined by the already placed guide catheter. Referring to FIG. 25B, the clamshell of the TurboTorquer 1136 is opened and the Y connector 1148 of interventional catheter 1152 is placed in clamp 1144 with the guide wire resting across the lower clamshell of TurboTorquer 1136. To accommodate the natural position of the Y connector given the given patient and the length of the particular interventional catheter, the whole combined assembly that includes the TurboTorquer 1136 and the holder for the interventional-catheter Y connector clamp 1144 and its support block 1140 can be moved linearly to a suitable position along channel 1124 by rotating the threaded rod 1128 clockwise or counter clockwise as appropriate to move the square support nut 1136 to the desired position. With reference to FIG. 26, the guide wire is laid in groove 1220 of the TurboTorquer and the clamshell closed. The guide wire can then be advanced or retracted by controlling stepper motor 1208 which turns active drive-wheel disk 1212. Since the guide wire is clamped securely within the TurboTorquer clamshell, it can be rotated as well by controlling stepper motor 1224 which through attached gears 1228 turns the two assembled half-gear sets made up of gears 1232 mating with gears 1252 and thus the combined dowel made up of half dowels 1236 and 1216. This is done while simultaneously applying the clamps 1230. Simultaneous linear and rotary motions are obtained by rapidly alternating the use of the linear and rotary drives with the clamps 1230 applied during the rotary action and released during the linear action.

Linear and rotary maneuvers involving small or large motions are performed to navigate the guide wire through a vascular structure such as the coronary arteries. Once the guide wire has been threaded through an obstruction, the interventional catheter, whether a balloon catheter or a stent, is moved over the wire to the designated location of the obstruction and the given balloon expanded. Contract medium can then be injected to assess the result. The interventional catheter or both the interventional catheter and the guide wire are removed if the procedure is completed.

If the guide wire is to be left in place so the interventional catheter can be exchanged, the following steps can be performed. The square support nut 1136 as shown in FIG. 25B is moved backwards on the rear stage by the rotation of the threaded rod 1128 by stepper motor 1120 as shown in FIG. 25A. This maneuver will withdraw the catheter, but to keep the guide wire in place (important, for example, if it has been threaded through a coronary-artery lesion) the guide wire must be relatively advanced which can be done by using the linear drive-wheel disk 1212 of the TurboTorquer as shown in FIG. 26. Thus as the TurboTorquer moves backwards, the guide wire is moving forward relative to the TurboTorquer and thus remains in place within the body of the patient. When the interventional catheter is withdrawn to the extent that it clears the front-stage clamshell, the guide wire is firmly held using clamp 1068 on clamshell support 1032 as shown in FIG. 22A to ensure no movement within the body of the patient. It is then safe to completely remove the interventional catheter from the guide wire manually and to thread on a new one manually over the guide wire into the patient's body to the point where the Y connector of the replacement interventional catheter is again clamped into clamp 1144 as shown in FIG. 25B and the guide wire again placed in the TurboTorquer 1132. The maneuvers involving the replacement interventional catheter are now initiated.

An embodiment for measuring force feedback during the course of the catheter or guide wire is shown in FIG. 27 in which the mechanical driving of the catheter occurs to the right of the drawing and where catheter components 1300 and 1304 are separated by a fluid-filled space 1308. Fluid loss is prevented by the sheath (sides of which are 1312 and 1316). Force measurement from force from the left on catheter or guide-wire segment 1300 is performed using strain gauge or other force sensor 1320 which is anchored to the two catheter or guide-wire segments 1300 and 1304 by attachments 1324 and 1328 respectively.

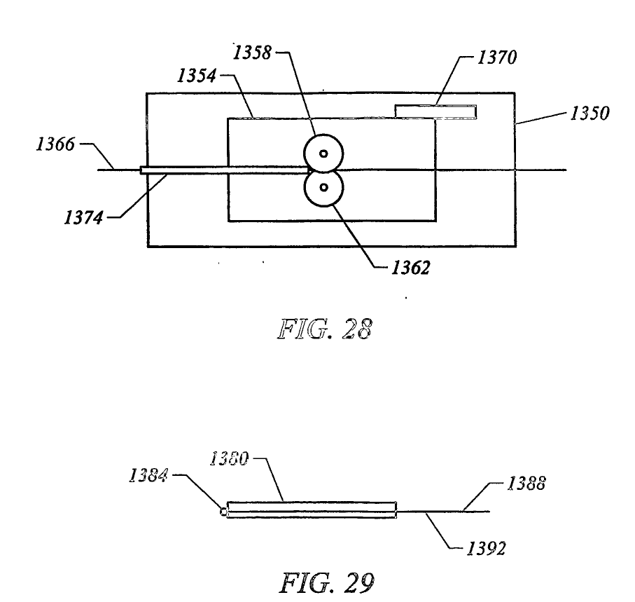

An alternative embodiment is illustrated in FIG. 28 with the strain-gauge or other force sensor 1370 measuring the force between base platform for the drive wheels 1350 and the drive assembly 1354 that is riding in tracks on base platform 1350 that are not shown. The force on the catheter or guide wire 1366 is transmitted back to the active drive wheel 1358 and the tension wheel 1362. This is possible because the catheter or guide wire 1366 is enclosed in a tube 1374.

Another alternative embodiment is shown in FIG. 29 in which force is measured at the tip of catheter or guide wire 1380 by sensor 1384 with signals from and power to the sensor being provided by the pair of wires 1388 and 1392 that are in or on the walls of catheter (or in the core of guide wire) 1380. An alternative method of signal communication is to use a miniature radio transmitter in place at or near the tip of the wire or catheter to transmit signals representing force either to a point outside the patient or to receiver at or near the tip of the guide catheter. The signal is then relayed by wires embedded in the wall of the guide catheter. Those same wires or an additional pair of wires can supply power to the receiver. An another alternative embodiment is to place a tiny strain gauge on one or more sides of the catheter near the tip (connected for signal and power as previously described) and look for deformations due to bending of the catheter because of forces applied to the tip by hitting the wall of a vessel or while attempting to tunnel through a lesion.

While the above is a complete description of preferred embodiments of the invention, various alternatives, modifications, and equivalents can be used. It should be evident that the invention is equally applicable by making appropriate modifications to the embodiments described. Therefore, the above description should be taken as limiting the scope of the invention that is defined by the metes and bounds of the appended claims along with their full scope of equivalents.

What is claimed is:

1. A method of manipulating an elongate member during a medical procedure, comprising:
receiving input from a user to manipulate the elongate member;
sending signals to advance the elongate member if the input directs advancement of the elongate member;
sending signals to retract the elongate member if the input directs retraction of the elongate member; and
sending signals to rotate the elongate member if the input directs rotation of the elongate member.

2. The method of claim 1, wherein the elongate member is flexible or rigid.

3. The method of claim 1, wherein the signals specify a speed that is proportional to movement of a pointing device.

4. The method of claim 1, wherein the input is received from a pointing device coupled to a computer system.

5. The method of claim 1, wherein the signals to advance the elongate member direct a motor to rotate a wheel in contact with the elongate member.

6. The method of claim 1, wherein the signals to retract the elongate member direct a motor to rotate a wheel in contact with the elongate member.

7. The method of claim 1, wherein the signals to rotate the elongate member direct a motor to rotate a base that is coupled to the elongate member.

8. An apparatus for manipulating elongate members during medical procedures, comprising:
a base coupled to an elongate member, the base being capable of rotation along an axis parallel to the elongate member;
a first motor coupled to the base that advances or retracts the elongate member along the axis; and
a second motor coupled to the base that rotates the base, whereby the elongate member is rotated around the axis.

9. The apparatus of claim 8, wherein the relative speed of the first and second motors provides coordinated motion.

10. The apparatus of claim 8, wherein the first motor advances or retracts the elongate member by rotating a wheel in contact with the elongate member.

11. The apparatus of claim 10, further comprising a biasing mechanism to bias the elongate member against the wheel.

12. The apparatus of claim 8, further comprising a clip to retain the elongate member.

13. The apparatus of claim 8, further comprising a computer system that receives user input to direct the first and second motors.

14. A method of manipulating an elongate member during a medical procedure, comprising:
retracting two elongate members where a first elongate member is within the lumen of a second elongate member; and
advancing the first elongate member relative to the second elongate member.

15. The method of claim 14, wherein the first elongate member is advanced to substantially counter retraction caused by the retraction.

16. An apparatus for manipulating elongate members during medical procedures, comprising:
a drum coupled to two elongate members where a first elongate member is within the lumen of a second elongate member, the drum being rotatable along an axis perpendicular to the two elongate members and comprising a clip to retain the second elongate member such that when the drum rotates, the second elongate member is retracted along a first direction; and
a wheel coupled to the drum such that the rotation of the drum also rotates the wheel and the first elongate member is retracted along the first direction, wherein the wheel rotates to advance the first elongate member along a second direction opposite the first direction.

17. The apparatus of claim 16, wherein the elongate member is advanced to substantially counter retraction caused by rotation of the drum.

18. The apparatus of claim 16, further comprising a motor coupled to the drum that rotates the drum.

19. The apparatus of claim 16, further comprising a motor coupled to the wheel that rotates the drum.

20. The apparatus of claim 16, further comprising a computer system that receives user input to direct rotation of the drum, wheel or both.
